(19) United States
(12) Patent Application Publication
(10) Pub. No.: US 2006/0267967 A1
(43) Pub. Date: Nov. 30, 2006

(54) Phrasing extensions and multiple modes in one spring-loaded control

(75) Inventors: Kenneth P. Hinckley, Redmond, WA (US); Francois Victor Jacques Jerome Guimbretiere, Baltimore, MD (US); Georg Manfred Apitz, College Park, MD (US); Nicholas Yen-Cherng Chen, Greenbelt, MD (US); Maneesh Agrawala, Seattle, WA (US); Raman K. Sarin, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/282,404

(22) Filed: Nov. 18, 2005

Related U.S. Application Data
(60) Provisional application No. 60/683,996, filed on May 24, 2005.

(51) Int. Cl. G09G 5/00

(52) U.S. Cl. 345/179

(57) ABSTRACT

Provided are techniques for extending the capabilities of pen-based interfaces. Embodiments are provided that receive an input that can include a selection, a confirmation, and/or a completion or cancellation. According to some embodiments tension-based techniques (hardwired or software) provide an interface whereby a user can confirm, cancel, or terminate a selected command gesture. The various embodiments employ techniques that include muscular tension and/or pen contact with a screen. Also provided are spring-once techniques that keeps the tool active for one use after a button has been deactivated.

### CROSS-REFERENCE TO RELATED APPLICATIONS

This is an application claiming benefit under 35 U.S.C. § 19(e) of U.S. Provisional Patent Application Ser. No. 60/683,996, filed May 24, 2005, and entitled “EXTENDED CAPABILITIES OF PEN-OPERATED DEVICES.” The entirety of this application is incorporated herein by reference.

### BACKGROUND

Pen interfaces for tablet computers offer the speed and transparency of note taking on paper, however, they often borrow techniques such as menus and icons from the desktop interface. If each icon selects a different tool, then the prevalence of modes demands vigilance from the user and slows down the user when the user interleaves commands and plain ink strokes. When an identical input action yields different results depending on the state of the system, the system exhibits a mode. A user commits a mode error when the user fails to comprehend the current state of the system and thus performs an action, which is incorrect given the true state of the system.

Techniques that help users assess the state of a system with minimal demands on attention, such as audio feedback or using modes maintained through muscle tension can be utilized. For example, switching modes by pressing and holding a foot pedal reduces mode errors, but a latching foot pedal that holds its state does not produce the same benefit.

Some pen interfaces seek to phrase together multiple subtasks within a single pen stroke. This single-stroke strategy is tempting because it represents an actively maintained mode that phrase subtasks together and thus may help avoid modes. However, a single-stroke strategy has limitations. For example, a user may be allowed to draw multiple individual strokes to cross each widget in a dialog box. If the user instead had to do all of this in a single continuous stroke, a mistake late in the process would force the user to start over. Similarly, the simple hierarchical marking menus, which use multiple straight pen strokes, result in lower error rates than compound hierarchical marking menus that require a single stroke (with pauses or inflection points delimiting the hierarchy).

A multi-stroke approach has limitations as well because it is not clear which successive strokes should be interpreted as a single contiguous input phrase, or alternatively, interpreted as the start of a new phrase. For example, simple marking menus require a time-out between each successive stroke because, during the time the pen leaves the screen, it is not clear what the user wants. When the user makes a mistake and wants the menu to disappear, waiting for the time-out is tedious. Yet, if the user hesitates while remembering the direction of the next stroke, it is frustrating for the menu to time-out.

A basic problem with various approaches is that the system sees the pen contacting the screen at random times and it is unclear which pen strokes should be phrased together with which other pen strokes. Thus, to overcome the aforementioned as well as other problems associated with user interface devices, simple and efficient interaction techniques are provided.

### SUMMARY

The following presents a simplified summary of one or more embodiments in order to provide a basic understanding of some aspects of such embodiments. This summary is not an extensive overview of the one or more embodiments, and is intended to neither identify key or critical elements of the embodiments nor delineate the scope of such embodiments. Its sole purpose is to present some concepts of the described embodiments in a simplified form as a prelude to the more detailed description that is presented later.

In accordance with one or more embodiments and corresponding disclosure thereof, various aspects are described in connection with phrasing for pen gesture interfaces and marking menus. According to various embodiments, is a technique for utilizing tension of a non-preferred hand to support a plurality of input phrases, ranging from simple one-stroke commands to complex scopes with decorations that allow the user to specify powerful operations. Some embodiments also encapsulate all interface modes within the input phrase itself.

One embodiment, referred to as the Springboard, is an interaction technique that extends spring-loaded modes (sometimes referred to as quasimodes) to encompass multiple tool modes in a single spring-loaded control. Spring-loaded modes maintain a mode while the user holds a control, such as a button or key. The Springboard allows the user to continue holding down a non-preferred-hand command button after selecting a tool from a marking menu as a way to repeatedly apply the same tool.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a system for extending the capabilities of multi-stroke gestures.

FIG. 2 illustrates a system for accepting various gesture commands utilizing tension modes.

FIG. 3 illustrates a timing diagram of an example user interaction for full-tension phrasing.

FIG. 4 illustrates a system for receiving a gesture selection.

FIG. 5 illustrates exemplary scope operators.

FIG. 6 illustrates an exemplary multiple edge alignment.

FIG. 7 illustrates an exemplary rotation around a center using the carat.

FIG. 8 illustrates an exemplary Flip command with an implicit group.

FIG. 9 illustrates a technique to extend a quasimode associated with a single spring-loaded control to multiple modes.

FIG. 10 illustrates a methodology for performing various commands utilizing a tension mode.

FIG. 11 illustrates another methodology for performing various commands utilizing a tension mode.

FIG. 12 illustrates a block diagram of a computer operable to execute the disclosed embodiments.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component,” “module,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

As used herein, the terms to “infer” or “inference” refer generally to the process of reasoning about or inferring states of the system, environment, and/or user from a set of observations as captured through events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

As used herein, the term “phrase structure” refers to the general syntactical pattern chosen for system commands. For example, a single-stroke version can support an A-B-A task structure, where A refers to inking mode and B refers entering a gesture mode to select objects and initiate and/or invoke a command. B can be the single command phrase S₁-C₁-P₁, which is a single stroke with scope S₁, command C₁, and parameter P₁.

The term “phrasing technique” as used herein refers to the interaction technique utilized by a system to define the boundaries of a phrase in terms of elemental input actions. The phrasing technique considers both the timing of the input (e.g., when the user can start or end the phrase) and the nature of the input (e.g., what the user does to start, maintain, or end a phrase).

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed embodiments.

While the embodiments shown and described in this detailed description include various components (and/or modules), it should be understood that the embodiments may include additional components and/or may not include all of the components discussed with reference to the figures. It should also be understood that a combination of these approaches may also be used. The various embodiments disclosed herein can be performed on electrical devices that utilize touch screen display technologies and/or mouse-and-keyboard interfaces. Examples of such devices include computers (desktop and mobile), smart phones, personal digital assistants (PDAs), and other electronic devices both wired and wireless.

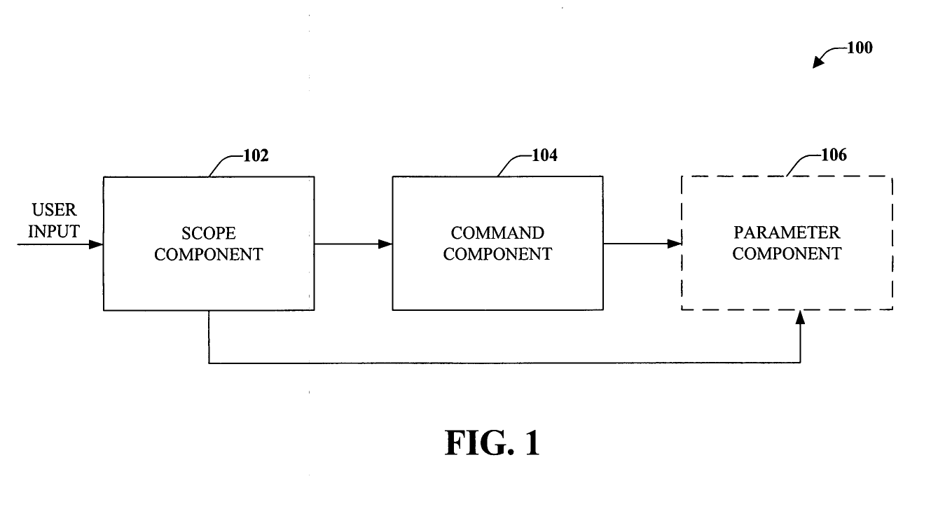

Referring initially to FIG. 1, illustrated is a system 100 for extending the capabilities of multi-stroke gestures of pen-based interfaces. System 100 includes a scope component 102 that defines the scope of a selection, a command component 104 that executes a command, and an optional parameter component 106 that performs one or more strokes specific to a selected command. A user can interface with system 100 utilizing various devices provided such device is capable of being detected by system. Such devices include a pen, a pointer, a finger, and/or any other object or device that provides pointing capabilities. Various modes can be utilized with system including inking (pen) mode, gesture mode, selection mode, eraser mode, highlighter mode, panning and zooming modes, and object creation modes (e.g., drag out a rectangle or ellipse).

Scope component 102 receives a user input provided through the pointing device by which a user makes one of a plurality of selection types. The scope can be empty (null e.g., by omitting any scope selection from the phrase or by selecting an empty space), or consist of one or more user selections (e.g., lasso, tap) on which a plurality of commands can be executed or performed (e.g., align, rotate, flip, pan, erase, move, and so on). Scope decorations, which are selection gestures that indicate a spatial property of an object (e.g., a crossing stroke can indicate an edge of the object for alignment), can also be input as part of the scope selection or parameter selection portions of the input phrase.

An input received by scope component 102 also includes a user tension aspect (hardware or software) through which a user notifies system 100 or confirms that one or more gestures are intended to invoke a command and resulting manipulation of objects (e.g., letter, word, item, or other displayed items) on the screen. For example, the user tension aspect can be a button in the non-preferred hand. Other embodiments can utilize the Ctrl key on a standard keyboard as the button. Other embodiments can utilize a touch sensor, touch pad, and/or one-dimensional touch-slider as the button, some of which can support additional functions such as bimanual scrolling. The entire display or bezel of a device can be a touch-sensitive surface, providing flexibility in placement of the gesture button, and allowing operation of the device while the user is holding it or using it in one of four different screen orientations.

Such tension signals system 100 that a pointing device should transition from an inking mode to a command gesture mode. Removal of user tension can indicate the cancellation or completion of the command and/or manipulation of objects, returning the pointing device to an inking mode. Inking mode refers to acts such as note-taking, drawing, and the like performed on an electronic display similar to pen and paper functions. Those skilled in the art will recognize that the default mode, referred to as “inking mode” herein, can alternatively be replaced by any other mode that an application uses as its “normal” mode of operation. For example, some applications may assign the “normal” mode as a selection mode, gesture mode, scrolling mode, dragging mode, or a user-selectable mode (e.g., airbrush, paintbrush, highlighter, etc.).

The user, though an interface with scope component 102, selects the objects (if any) on which to invoke a command, and command component 104 is configured to execute or perform such command. In some embodiments, the command can be distinguished from stroke gestures by a pigtail (a stroke that crosses itself like a cursive e), for example, and can be a single stroke or multiple-stroke simple marking menu. In other embodiments, any gesture starting from a box drawn at the end of the gesture stroke is treated as the command portion. In further embodiments, the final stroke of a phrase is treated as the command portion, if possible. Phrasing can be used to mitigate the need for a time-out between strokes of the simple marking menu or other multiple-stroke command mechanisms. These command gestures can include single or multiple strokes, depending on, for example, a command hierarchy and/or a command complexity. Command component 104 can also be configured to prompt a user to perform a command stroke through utilizing a visualization of the available menu choices, thus facilitating a gradual skill transition from novice prompt-based command input to quick expert stroke-based input. Exemplary strokes gradually become visible to the user based on various criteria, including but not limited to a parameter pre-selected by the user and/or a time-based determination. Such a prompt enables the user to draw the stroke by tracing or recreating the exemplary strokes. In such a manner, a novice user is able to recreate the stroke, thus gaining experience and transitioning to an expert user.

System 100 includes an optional parameter component 106 configured to perform one or more strokes specific to a command selected by a user (e.g., panning a canvas with multiple pen strokes or using the pen tip as an eraser). Some selected commands, such as flip, rotate, align, are executed solely by command component 104. However, some commands, such as erasing and panning, require further input from the user. For example, for a rotate command the user would select a particular point on the display area upon which an object (e.g., letter, word, item, or other displayed items) rotates. If, however, the user selects an erase command, parameter component 106 would maintain and continue the selected command (erase) until the scope component 102 indicates that the system 100 should return to an inking mode. Thus, not all commands require parameter component 106.

The command modes are active while the user activates and continues to hold a mode switch button, known as a springboard mode. This springboard mode mitigates the possibility of the user feeling trapped or distracted by having to deactivate any of these modes. Thus, system 100 illustrates how the articulation of the phrase itself can encapsulate selection, command, and tool modes, such that no mode exists beyond the tension that terminates the phrase.

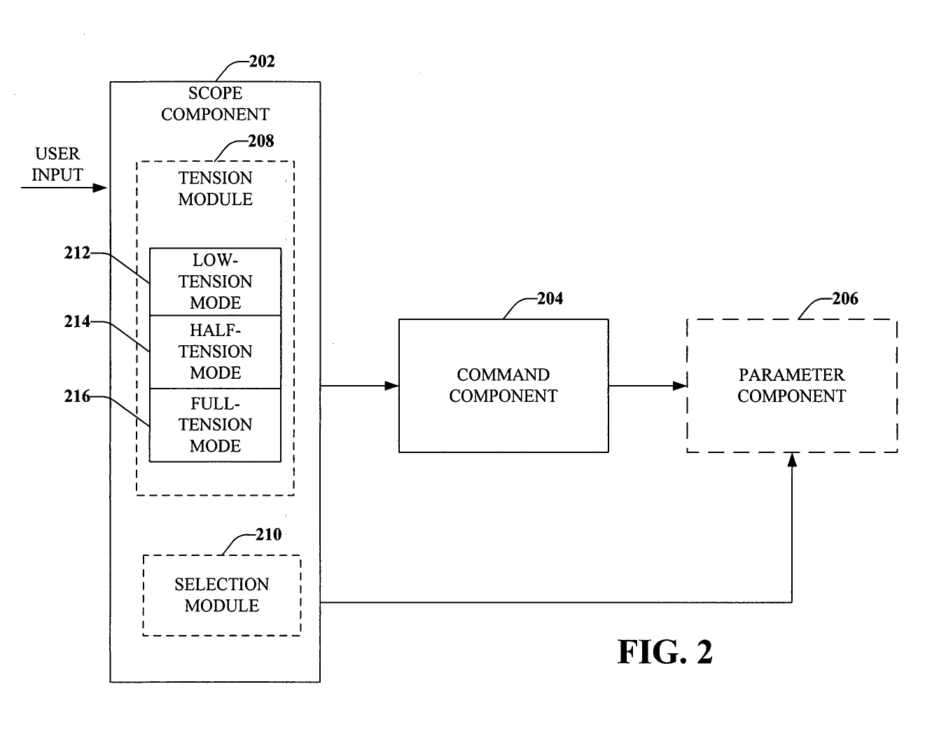

FIG. 2 illustrates a system 200 for accepting various gesture commands utilizing tension modes. System 200 includes a scope component 202 that interfaces with a command component 204 and a parameter component 206. Command component 204 is configured to execute various commands received from a user through scope component 202. Parameter component 206 is configured to perform one or more strokes specific to a selected command. The command is executed by command component 204 or parameter component 206 until a notification is received from scope component 202 to terminate or cancel the command.

Scope component 202 can receive a user input to execute a particular command on one or more objects. Scope component 202 can include a tension module 208 that receives a user notification and/or confirmation that a particular series of strokes is meant as a command, rather than an inking function and a selection module 210 that receives a selection input from a user. The notification can be performed by the user pressing a button, a Ctrl key, an area on a touch pad, and the like. If the bezel of screen of a touch pad is used as the button, a contact area z measurement can be utilized to estimate the pressure exerted. When the z-component meets or exceeds a threshold, the gesture mode could be entered. The threshold should take into account the compromise between a user needing to press too hard and accidental activation of light touches. In some embodiments, this threshold is dynamically adjusted according to the initial degree of contact during about the first few hundred milliseconds when the user (or object) starts touching the device.

The timing of both the onset and cessation of tension, or the degree of tension, can be utilized as criteria for phrasing together one or more input strokes. Thus, tension module 208 can support various phrase tension techniques including a low-tension mode 212, a half tension mode 214 and/or a full tension mode 216. While the tension modes herein are described in reference to a mechanical button, the various embodiments can alternatively utilize a software button or other interactive control on the display or the bezel of the device. The user activates one or more of these control(s) in accordance with the three tension modes, which will now be described.

Low-tension mode 212 is when a user produces muscular tension (depresses or activates the button) to introduce a new phrase, but then relaxes tension to release or deactivate the button. Proximity of the stylus to the screen is then used to continue the phrase. This low-tension technique allows the user to click (press and release) a mode switch button to start the phrase, keep the pen on or near (in proximity of) the screen to continue the phrase, and finally pull the pen away to end the phrase. The proximity range of a pen-based interface can be extremely close to the display screen for palm-sized devices and further away from the screen for wall mounted displays and any distance there between. The user might inadvertently pull the pen or other pointer away from the display screen between strokes, therefore, the technique should be tolerate of short gaps where the pen goes out-of-range before returning to proximity. A short time-out of approximately 600 ms, can mitigate such unintentional “stops,” while keeping the time to end a phrase (by intentionally removing the pen from the proximity of the screen) as short as possible. It should be noted that holding a pen barrel button rather than using proximity would not prevent this problem. In addition, a pen barrel button can be awkward to hold and may not generate an event when the pen is out-of-range. Nonetheless, a pen button which can be pressed and held, and which generates pen button press and hold events even when the pen is not in proximity of the screen, would be consistent with the phrasing techniques proposed herein.

The half-tension mode 214 is another embodiment for phrasing techniques. Here the user employs muscular tension at the start of a phrase, maintains the tension through the climax of the phrase, and there after can release the tension. If the user releases the button before issuing a command, the system forms a selection but takes no action on it. To instead act on a selection the user presses and holds the mode switch button while selecting the scope and continues to hold the button until the command selection. The articulation of a pigtail, or other delimiter, for command selection represents the culmination of the input phrase. The user can release the button at any time after the delimiter. In some embodiments, the half-tension mode allows users to select a command and then continue dragging in a single pen stroke, but one the user lifts the pen after choosing a command, this automatically terminates the phrase. This allows the user to issue several commands in succession while continuing to hold the button.

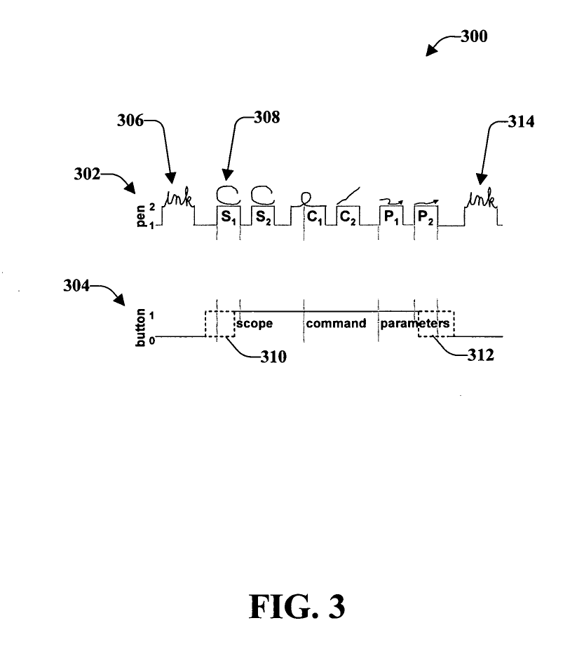

During full-tension mode 216, the user maintains muscular tension throughout the phrase. The user presses and holds the button at the beginning of the phrase and continues holding it until the last pen stroke. In the full-tension mode, users can select a command and then lift the pen while dragging without terminating the phrase. The user must lift the button, and then press it again, to start a new command. This is further explored in FIG. 3 below.

System 200 can support the tension modes described above. In some embodiments a user may desire to tailor the tension mode and system 200 can support such alterations. For example, a user may not want to hold down a button if keeping the pen in proximity of the screen is sufficient to maintain the mode (low-tension mode). Other users may tend to relax after reaching a climax of the tension, thus the half-tension mode may work best for some users.

FIG. 3 illustrates a timing diagram 300 of an example user interaction for full-tension phrasing. The user action with respect to the pen is illustrated at 302 and the user action with respect to the button is illustrated at 304. While the pen is in an ink mode 306, the button is not depressed. When a command is to be executed, the user can begin the scope S₁, such as a lasso, at 308. The mode switch button should be pressed before or at substantially the same time as the first scope action (lasso is illustrated) or before the end of the completion of the scope action (lasso). The time window in which the user should press the button is illustrated as a dashed box 310. If the button is not pressed during this time window 310, the first scope S₁ is recognized as an inking action, not a scope action.

Provided the button was pressed during the time window 310, the user can select none, one, or multiple other scopes, illustrated as lasso S₂. The user continues to hold the button and draws a pigtail to start a two-stroke simple marking menu command (C₁C₂). The user then makes two parameter strokes (P₁P₂). While two parameters are illustrated, there could be none, one, or a plurality of parameters.

If the user desires to exit the parameter during P₂, for example, the user would release the button during a time window 312 that extends from just after P₂, begins through a time after P₂ completes. At substantially the same time as P₂ ends or the button is released, whichever happens last, the pointer returns to an inking mode 314. Thus, it does not matter if the pen lifts first or if the gesture button lifts first at the end of the phrase. The dotted rising and falling edges of the windows 310 and 312 show how the timing of the button press and button release are relaxed.

Complex commands and simple phrases can be supported by the various embodiments disclosed including the following commands. Single-stroke commands with no scope or parameters (e.g., Save, Next Page) can be supported by the user drawing a single pigtail or other single-stroke gesture commands. Some embodiments also support commands with a single lasso scope and one, two, or more stroke command gestures (e.g., circle some ink, then choose Pens→Thin Red to change the ink style). Commands with a disjoint scope consisting of multiple lasso selections (draw lassos and then pigtail to Cut) are supported. Also supported are commands with multiple parameter strokes for direct manipulation within a mode (e.g., Erase, Pan, Move, . . . ).

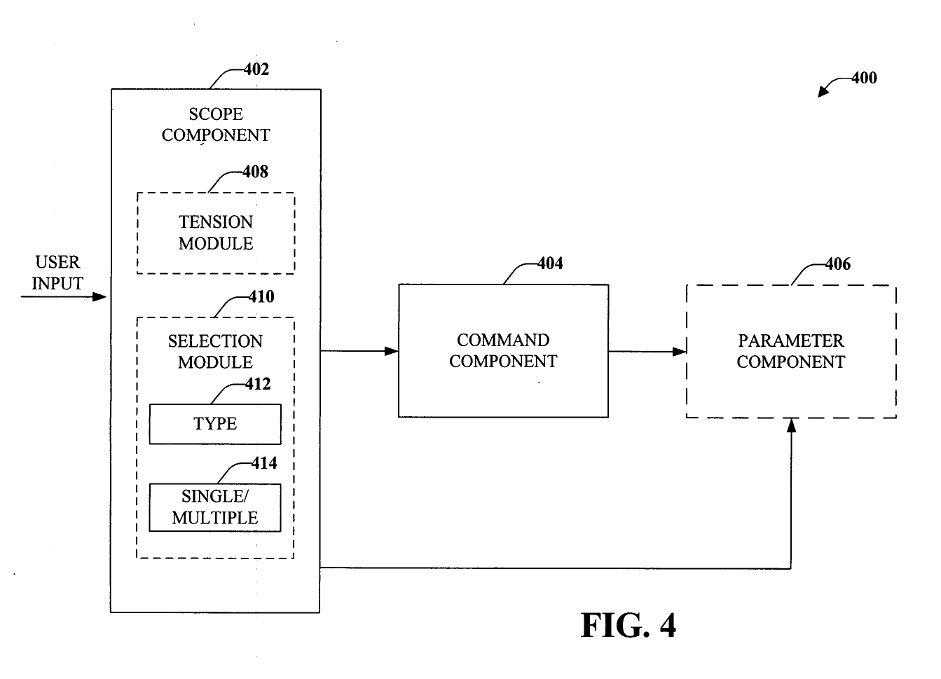

FIG. 4 illustrates a system 400 for receiving a gesture selection. System includes a scope component 402 that interfaces with a command component 404 and a parameter component 406 to provide selected user commands utilizing pen-based interfaces. Command component 404 is configured to execute a command selected by user through one or more gestures. Parameter component 406 is configured to accept further input from a user, through scope component 402 and/or directly from the user. Such further input is necessary for commands such as pan, erase, highlight, and the like. For example, a user may specify which object to move in the scope component, but then specify how and where to move through one or more “dragging” parameters. Parameter component 406 accepts further input and executes the selected function until a notification is received from scope component 402 that the user has terminated the command. The user can convey such notification through release of tension on a hardware or software “button” associated with system 400.

Scope component 402 can include a tension module 408 that receives a user notification and/or confirmation that a particular series of strokes is meant as a command, rather than an inking function and a selection module 410 that receives a selection input from a user. Selection module 410 can receive scope operators of a plurality of types 412, which will be described with reference to FIG. 3 below. Selection module 410 can also receive single or multiple selections 414. For example, a user can select one object or multiple objects. Such multiple objects can be a group of objects that are next to each other and selected collectively or each object can be at disparate locations on the display area and selected individually.

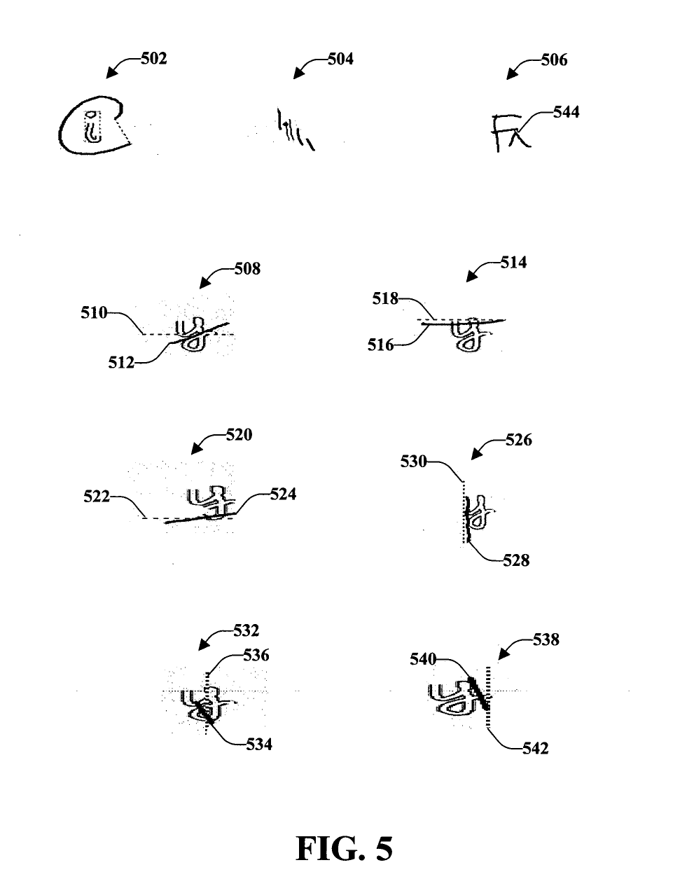

Exemplary scope operators are illustrated in FIG. 5. A lasso operator is indicated at 502 whereby a user circles or encloses an object to select such object(s). If the closed polygon implicitly defined by a partial or complete lasso contains the object(s), the system selects the object(s). Note that the object(s) that fall within the loop formed by a pigtail command may be considered as part of the selection according to some embodiments. If the distance between the first point of the stroke and the last point of the stroke is a substantial fraction of the length of the stoke itself, the stroke is not a lasso and the system attempts to find another interpretation of the stoke. Otherwise, the object(s) contained within the lasso stoke are selected. In some embodiments, if more than one object falls within the lasso, the objects are automatically turned into a single “implicit group” object, as indicated by a box around the “i”, that can be acted upon by subsequent selection gestures or scope decorations. Such implicit groups are automatically ungrouped at the end of a command phrase.

A tapping technique to select an object(s) is illustrated at 504. This involves simply tapping any place on the object(s). A carat (ˆ), as illustrated at 506 is another technique for selecting or pointing a specific reference point on one or more objects. A crossing operator is indicated at 508. Crossing is an alternative technique for object selection and involves drawing a straight line that crosses at least one edge of an object. In some embodiments, the user may cross more than one object in a single stroke. Crosses may also select empty space (e.g., cross no object, but indicate a reference position relative to the background).

To take advantage of the different spatial properties indicated by each scoping operator, the various embodiments support scope decorations, which are scope operators that select an object and indicate a spatial property of the object. Lasso, carat, and crossing are three types of scope decorations that can be used separately or composed to indicate complex operations. As mentioned above, some embodiments automatically create a group object, known as an implicit group, when the user lassos multiple objects. The carat is used to specify an optional center of rotation for a Rotate command, for example.

Crossing highlights the closest principle edge of an object (shown as a “y” for example purposes). At 508, the horizontal middle 510 of the “y” is selected by the user stoking through the middle section 512 of the “y”. To select the top of an object 514, the user strokes 516 close to the top of the object and the top is highlighted as indicated by dashed line 518. In 520 the bottom of the “y” is selected 522 by a corresponding user stroke 524. Shown at 526, if the user marks near the left edge 528 of the “y,” that edge of the object is highlighted 530. Illustrated at 532 is a user stroke horizontally 534 through a middle section of the “y,” which highlights the vertical middle 536 of the object. The object 538 illustrates that if the user strokes toward the right edge 540 of the object that edge 542 is highlighted. As illustrated the user stroke(s) 512, 516, 524, 528, 534, and 540 do not have to be accurate, provided they touch a portion of the principle edge where the highlighted mark 510, 518, 522, 530, 536, and 542 is desired.

Drawing a scope decoration gesture on or near an object selects some spatial property of the object. As a convenience, if the object is not already selected, it may be selected as well. However, scope decorations do not exclude objects from a selection. Adding a decoration to an already selected object does not toggle its selection bit, it just decorates it. This allows multiple decorations to be composed on objects in a scope. To exclude an object from a selection, the user can tap on that object. It is also possible to use the lasso(s) 502 to specify circles of exclusion.

Decorations can add feedback to a decorated object beyond the normal selection feedback. For example, the crossing scope decoration is a dotted line that identifies the snap edge that is nearest to the crossing stroke, as illustrated at 510, 518, 522, 530, 536, and 542. The carat shows a box at the selected point 544. Decorations do not necessarily have to be attached to a specific object. The user can place the carat over white space, for example.

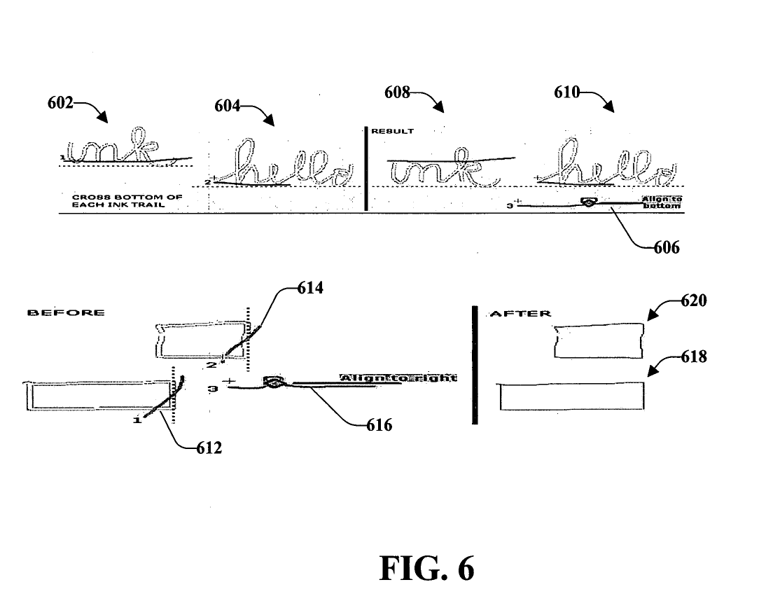

FIG. 6 illustrates that a user can use the crossing scope operator to indicate edges of objects for alignment. The user crosses the bottom of the word “ink” 602 and then cross the bottom of the word “hello” 604. A third stroke with a pigtail 606 activates the alignment command. The result for each word is shown at 608 and 610.

At the bottom of the figure are two squares. The user vertically crosses the right edge of the first square 612 and then the right edge of the second square 614. The next mark is a pigtail 616 resulting in a vertical alignment. After the alignment, the squares are in the position illustrated at 618 and 620. Thus, the final edge crossed is used as the reference edge (the edge that is aligned to). If the user misses the intended edge, the user may cross the object again to override the previous stroke. It should be understood that while various embodiments have been illustrated with reference to words, letters, squares, etc. any type of object can be manipulated according to the disclosed techniques.

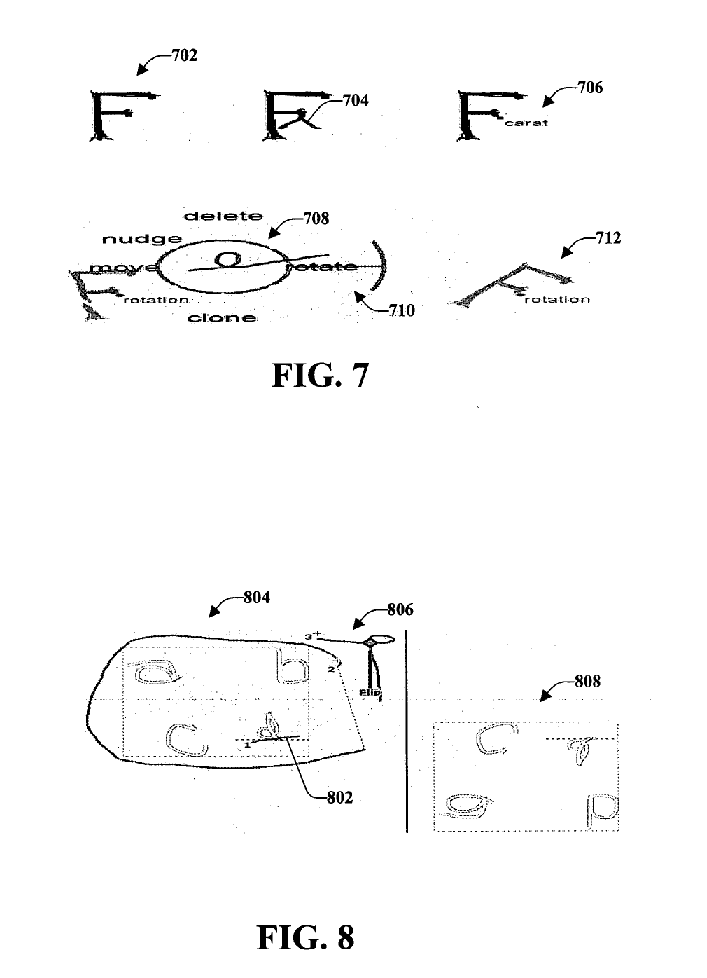

FIG. 7 illustrates an exemplary rotation around a center using the carat. The carat scope operator, illustrated in FIG. 5 at 506 selects a point on an object or on an empty background (canvas). Illustrated is an “F” in a first position at 702. The user draws a carat scope operator 704. The system marks “carat” 706 as a feedback for scope determination. The user invokes a pigtail menu 708, and chooses the Rotate command 710. Dragging the pointer rotates the object “F” around the center of rotation (carat point) 712 through direct manipulation.

In many ink applications, drawing a lasso (as discussed with reference to FIG. 5 element 502) around ink strokes allows commands to act on the strokes as a unit. The lasso can specify an implicit group in the scope of a command. When the user draws a lasso, it acts as if the user had selected the objects and applied a Group command. However, implicit groups are flagged internally, so that when they become deselected, the Ungroup command is automatically applied. Thus, the “group’ only exists during the articulation of the command. An implicit group is indicated to the user by drawing a dotted rectangle around the selected objects. This is shown in FIG. 5 at 502.

For most commands, the creation of the implicit group is irrelevant and of no concern to the user. However, sophisticated operations can be performed by using scope decorations and implicit groups together. FIG. 8 illustrates an exemplary Flip command with an implicit group. The user first cross “d” 802, then lassos “a,” “b,” “c,” and “d” 804. The user then pigtails 806 to select the Flip command. The Flip command rotates the implicit group about the bottom of “d” 808.

To instead flip “a,” “b,” “c,” and “d” around their collective right edge, for example, the user would first lasso the objects (thus creating the implicit group), then cross the right edge of the implicit group, and then chooses Flip. This pivots the objects about the rightmost edge. Implicit groups can also be nested by drawing a lasso that encompasses one or more previous lassos.

These commands illustrate how users can specify complex operations without having to repeatedly Group, act on, and then Ungroup the objects. The commands can act on either single objects or scopes that implicitly preserve the relative spatial relationship between a set of objects (by using a lasso to implicitly group the objects). Thus, various commands (e.g., Flip, Align, . . . ) can remain simple with the spatial properties needed to give meaning to the command coming from the strokes that together specify the scope. This reduces the number of commands that must be presented to the user, and may also reduce the number of explicit steps required to perform compound operations. It also makes it possible to realize complex spatial operations (e.g., flipping a group of objects about a specific edge as shown in FIG. 8) that are difficult to express with some input techniques.

Phrasing techniques can also be applied to multiple-stroke command input mechanisms. For simple marking menus, the user utilizes tension of a non-preferred hand to phrase together strokes and mitigates the necessity for a time-out. The user presses and holds the button to start gesture mode, and then can do a pigtail gesture to activate the menu. In a two-level menu selection, the user draws the pigtail to make the first-level selection, and then lifts the pen. In some embodiments, if after about 850 ms (timeout) the pen still has not started the second stroke, the user can be prompted with a submenu, centered at the end of the first stroke. Starting the second stroke before the end of the timeout allows “experts” to perform marking without prompting.

If the pen moves within the proximity tracking range of the screen, an animated compass star can be displayed. This visually reinforces the mode and suggests that a stroking motion is necessary to select a menu item. Once prompting starts, the submenu prompt follows the pen. This reinforces that the next stroke of the simple marking menu can start anywhere the user chooses. If the user releases the button before then pen starts the second level stroke, this immediately cancels the entire menu (including submenus). The user does not have to wait for a timeout to expire before continuing. When a user exits a mode, clear visual cues (the cursor for the tool mode disappears) and/or auditory feedback (a sinking “whiff” sound plays) can be utilized to reinforce that the user has exited the mode.

In some embodiments, to recall a prior selection, the user can tap twice on the mode switch button. The user then holds down the button and can modify the prior selection (if desired) before proceeding with a new command as usual. In other embodiments, a “recall selection” icon or a double tap of the pen can be used in addition or alternatively.

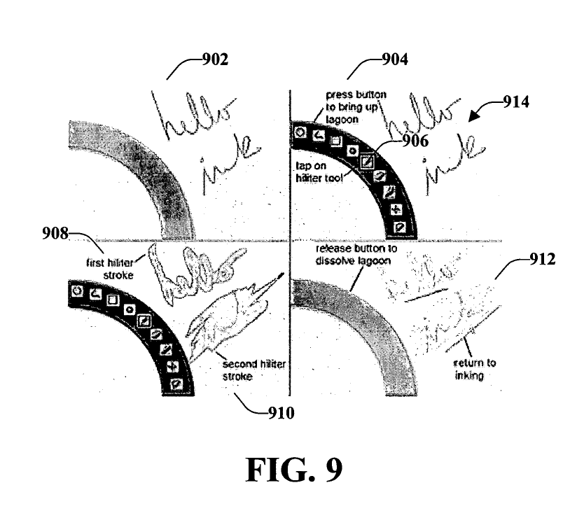

The tension control techniques described above can be envisioned either as a way to specify zero, one, or more parameters to a command, or as emphasized here, as a means to apply a tool modes zero, one, or more times in an interactive system. FIG. 9 illustrates a technique to extend a quasimode associated with a single spring-loaded control to multiple modes, referred to as a springboard. Instead of mapping one control to one mode, the springboard allows users to pass through two sub-modes. The springboard starts with a command selection sub-mode by presenting commands representing various tools in a menu. After the user selects a tool, the springboard transitions to a command performance sub-menu where the user can apply the selected tool multiple times. Similar to a traditional quasimode, relaxing tension returns to the application's default mode.

By way of illustrations, FIG. 9 illustrates the springboard concept as applied to an arc-shaped menu in the lower left corner of the screen, referred to herein as a tool lagoon, but it can also be applied to gesture-based means of indicating commands, such as marking menus. Inking mode 902 can be a default command. To use the springboard the user presses and holds a non-preferred hand button 904. The user then taps on an icon such as the highlighter tool 906 or makes a marking menu selection on the background (not illustrated) to choose the desired tool mode. As long as the user continues to hold the button, the user extends the input phrase and can apply the chosen mode by making one 908 or more 910 pen strokes. Releasing the button 912 turns off the tool mode and returns the application to its default mode. In the example of FIG. 9, the user then resumes drawing ink strokes on the screen.

The springboard can be applied to a “local” menu that the user activates from the current pen position, or to “remote” menus that lie at the edges of the screen (as shown in FIG. 9). For the local menu, a marking menu, for example, can be triggered by stroking while pressing a non-preferred-hand button. For the remote design, a marking menu can be triggered from any type of toolbar or menu that is not attached to the current cursor position, such as a tool lagoon 914, which is a type of toolbar that arcs out from a corner of the screen. FIG. 9 shows the tool lagoon at the bottom left, but in some embodiments it can be dragged to a new position by the user or it may automatically appear at other locations on the display. In this case, the starting location of the pen stroke already signals that the mark is a command, so the springboard can use the button to keep the selected tool mode active. This offers significant timesavings to users when the tool is utilized multiple times in a row, yet still allows users to quickly switch back and forth to a default mode, such as “inking.” In some embodiments, the tool lagoon is highlighted or dissolved at the time of the button press and release, respectively.

The springboard brings the benefits of a quasimode to multiple tool modes because it encompasses all the modes in a pop-up menu within a single spring-loaded control. Similar to other techniques that keep a selected mode on until the user chooses a new tool, springboard amortizes a command selection across several operations. Unlike those other techniques, however, springboard is more efficient in both one-time and multiple-user scenarios because the user just has to release the button to return to the default mode rather than explicitly reselecting the prior mode from a menu, toolbar, or other interface widget.

According to some embodiments, a “spring-once” technique can be utilized. If a user selects a tool without applying it and then lets go of the button, it is unlikely that they actually wanted to transition back to inking immediately. Thus, the spring-once technique keeps the tool active for one use. If the user instead continues holding the button until they start applying the tool, spring-once allows the user to keep holding the button to apply the tool multiple times, similar to that described above.

The spring-once technique is useful for users that tend to release the button too early when applying a tool one time. If the user selected a command by mistake and their intention was to immediately return to inking, the user can tap the pen or press the button again to cancel.

In some embodiments, the selected tool can remain across invocations of the springboard. Thus, the springboard lagoon can reactivate the most recently selected tool if the user hits the button and strokes the pen without moving the pen to the lagoon. This allows users to quickly interleave inking with another mode and facilitates tasks such as panning around and annotating a document or going through a document with a highlighter while also jotting down notes.

In some embodiments, if the user employs the lagoon without the button, the lagoon defaults to a “once” behavior where a tool mode is applied one time after selecting the command, and then automatically reverts to the default mode. But if the user instead presses and holds the button before completing the first application of the tool mode, this instead triggers the spring-once behavior described above. Note the lagoon may still partially highlight and dissolve in this embodiment, but it has to remain actionable in the “dissolved” state to support this technique.

Some embodiments provide a means to “lock” the springboard so that the currently selected tool mode stays active, allowing a user to work in a tool mode other than the default mode for a long period. However, the “locked” bit may result in a mode error if the user forgets the mode is locked and tries to use the springboard as usual. Thus, some embodiments employ a hardware implementation such as a latching button to provide tactile feedback of the locking function. This allows the user to “feel” that the physical control is locked when an attempt is made to activate it. Thus, if the user forgets the mode was locked, they would feel this at the first instant they tried to press the button rather than having to wait until they had already committed the pen to the screen, thus performing a mode error.

Occasionally the user may want to apply the tool near the vicinity of the lagoon. The lagoon can be hidden if the user drags through the arc while applying the tool. This allows the user to see where the tool is being applied without the lagoon occluding that area. The user can also pan and/or scroll the document or drag the lagoon to other corners of the screen.

In some situations, performing a pen gesture or marking menu command selection local to one's current working position may offer performance versus moving the pointing device to a toolbar or other widget. To support command reselection behavior in a local marking menu, the menu can remain posted after the user selects a tool. The user can then tap on an item from the menu to pick a new command without having to release the button and press it again. Note that the user does not have to let go of the button and press it again to issue another command.

In some embodiments, a selection tool mode is the default behavior upon activating the springboard. Thus, the user can either immediately start a gesture phrase by forming a selection by drawing with the pen or the user can move the toolbar lagoon to choose another desired mode. This embodiment combines the tool lagoon with the gesture interfaces discussed above where the user starts by forming an optional selection, then draws a pigtail or other delimiter to choose a command and finally applies that tool mode zero, one, or more times while holding the button, as discussed above for the “full tension” mode.

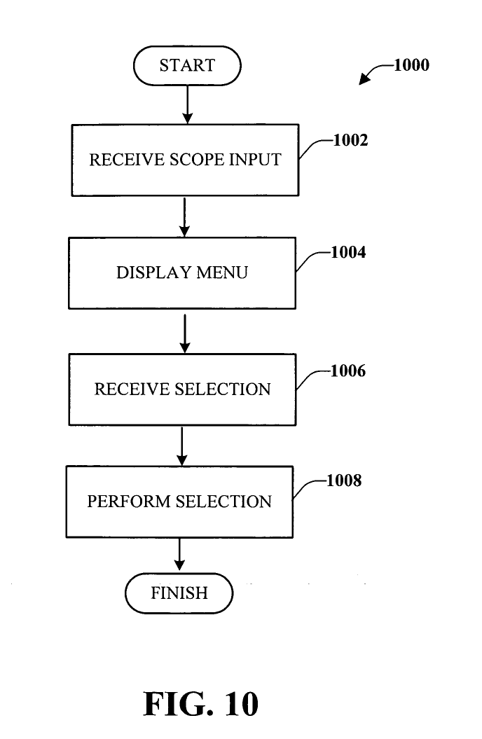

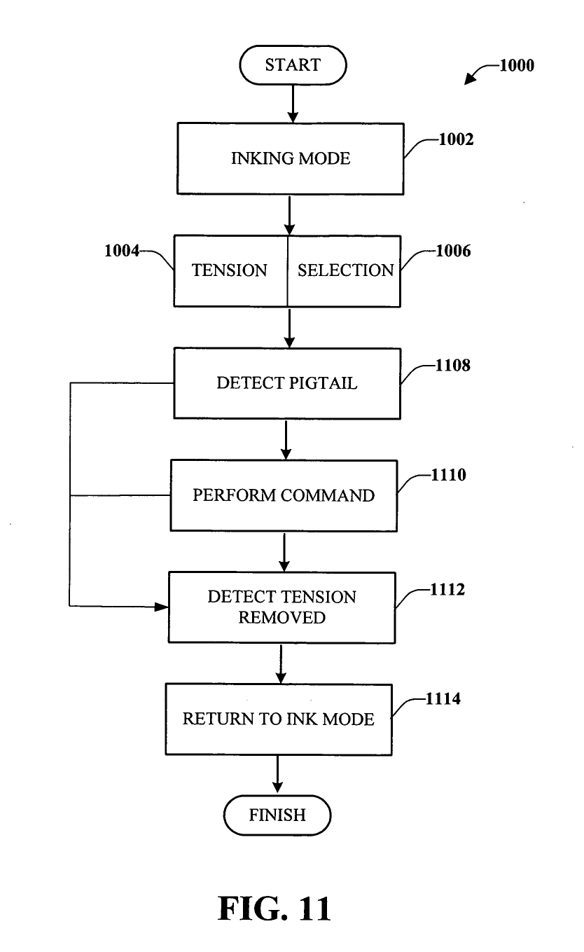

In view of the exemplary systems shown and described above, methodologies, which may be implemented in accordance with one or more aspects, will be better appreciated with reference to the diagram of FIGS. 10 and 11. While, for purposes of simplicity of explanation, the methodologies are shown and described as a series of acts (or function blocks), it is to be understood and appreciated that the methodologies are not limited by the order of acts, as some acts may, in accordance with these methodologies, occur in different orders and/or concurrently with other acts from that shown and described herein. Moreover, not all illustrated acts may be required to implement a methodology in accordance with one or more aspects of the disclosed embodiments. It is to be appreciated that the various acts may be implemented by software, hardware, a combination thereof or any other suitable means (e.g. device, system, process, component) for carrying out the functionality associated with the acts. It is also to be appreciated that the acts are merely to illustrate certain aspects presented herein in a simplified form and that these aspects may be illustrated by a lesser and/or greater number of acts. Moreover, not all illustrated acts may be required to implement the following methodologies. Those skilled in the art will understand and appreciate that a methodology could alternatively be represented as a series of interrelated states or events, such as in a state diagram.

Referring now to FIG. 10 illustrated is a methodology 1000 for performing various commands utilizing a tension mode. The method 1000 starts, at 1002, where a scope input is received from a user. This scope input can be a selection of one or more objects on a user display and/or a user pressing or activating a button. At 1004, a menu of various commands corresponding with the scope input is displayed. This menu can be centered around the pointer or other visualization means. At 1006, a user selection for a command from the menu is received. The command is performed at 1008 and can utilize both scope and command selections. The command is performed proved the tension input is still active at substantially the same time as the beginning of the command performance. If the tension is removed at any time before the beginning of the command performance, the command is cancelled. If the tension is removed after the beginning of the command performance, the command is still executed. The user can subsequently undo the command if after selection it is determined that the command is no longer desired.

FIG. 11 illustrates another methodology 1100 for performing various commands utilizing a tension mode. The method 1100 begins, at 1102, while in an inking mode. Inking mode is the default mode and includes such acts as note taking, drawing, and the like. At substantially the same time, a user muscular tension device is activated, at 1104, and a selection of one or more objects is received, at 1106. The muscular tension device can be activated before or at substantially the same time as the objects are selected, provided the tension device is activated before completion of the first object selection.

The method continues, at 1108, where a pigtail or other delimiter action is detected. The pigtail action is a user request for a menu display. This pigtail action can be followed by a command selection (e.g., pan, edit, move, highlight, . . . ), which can be any type of menu selection including those commonly associated with a marking menu or toolbar. The displayed menu offers the user a choice of menu items. The chosen command is performed at 1110. The method 1100 continually monitors for deactivation of the muscular tension device, at 1112. If the device is deactivated before the method begins to perform the command at 1110, the command is cancelled and the method returns immediately to inking mode, at 1114. If deactivation of the tension device occurs after beginning of performance of the command, the command completes without regard to the status of the tension device. In some embodiments, the command just executed can be remembered for the next command selection and the user can easily reselect the previous performed command.

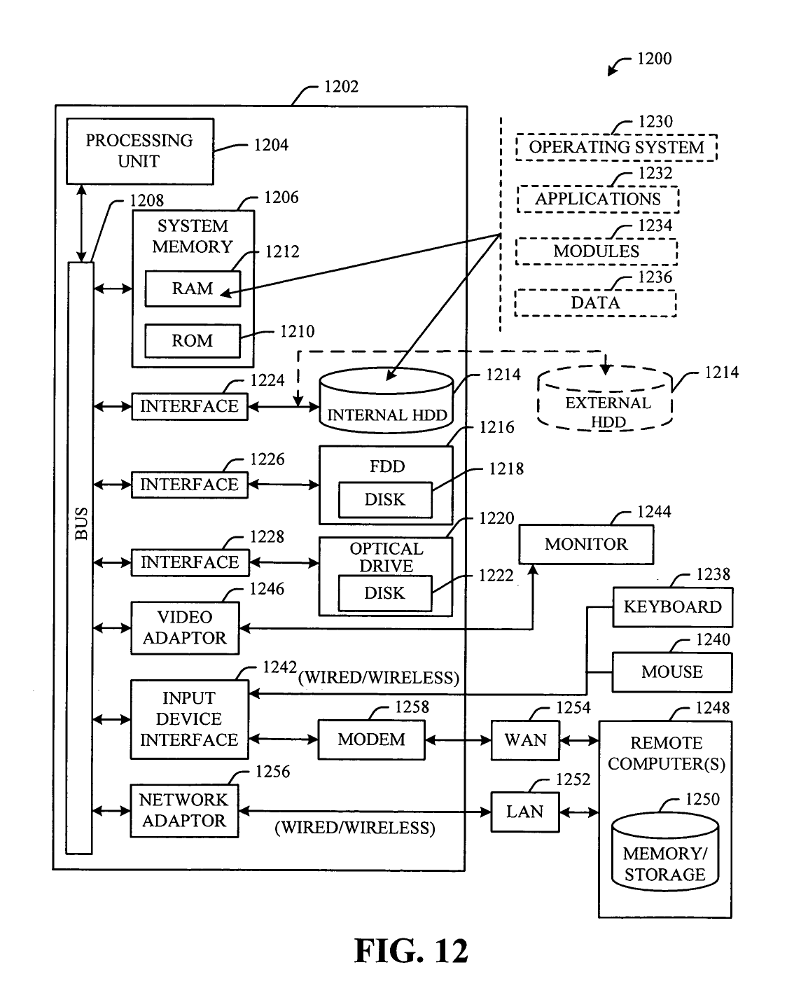

Referring now to FIG. 12, there is illustrated a block diagram of a computer operable to execute the disclosed architecture. In order to provide additional context for various aspects disclosed herein, FIG. 12 and the following discussion are intended to provide a brief, general description of a suitable computing environment 1200 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, the exemplary environment 1200 for implementing various aspects includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the one or more embodiments.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the various embodiments can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 through an interface, such as a video adapter 1246. In addition to the monitor 1244, a computer typically includes other peripheral output devices (not shown), such as speakers, printers, etc.

The computer 1202 may operate in a networked environment using logical connections by wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adaptor 1256 may facilitate wired or wireless communication to the LAN 1252, which may also include a wireless access point disposed thereon for communicating with the wireless adaptor 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 through the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates user command selection, comprising:
a scope component that defines the scope of a selection, the scope component includes a tension mode that confirms the selection; and
a command component that performs a selected command and returns to inking mode after execution of the selected command.

2. The system of claim 1, further comprising:
a parameter component that allows subsequent performance of zero, one, or more strokes specific to the selected command.

3. The system of claim 1, release of the tension mode signals cancellation or a partial command or completion of a fully selected command.

4. The system of claim 1, the tension mode is one of full-tension, half-tension, and low-tension.

5. The system of claim 1, the tension mode is activated before completion of the selection.

6. The system of claim 1, if the tension mode is activated after completion of the selection, the command component does not perform the selected command.

7. The system of claim 1, the scope component further remembers the command for reactivation after returning to an inking mode.

8. The system of claim 1, the command component further displays a menu upon detection of a user menu request.

9. A method for extending capabilities of interface devices, comprising:
detecting a user tension input and a user selection of at least one object, the user tension input is detected before completion of the selection of the at least one object.
receiving a desired user command,
determining whether the user tension input is still detected; and
executing the command.

10. The method of claim 9, the command is cancelled if the user tension input is removed before execution of the command begins.

11. The method of claim 9, the command is executed even if the user tension input is not detected after beginning execution of the command.

12. The method of claim 9, if the user tension input is received after completion of selection of the at least one object, the desired user command is not executed.

13. The method of claim 9, further comprising performing one or more strokes specific to the command though interaction with a device.

14. The method of claim 9, receiving a desired user command further comprising:
detecting a pigtail;
displaying a menu; and
receiving a menu selection.

15. The method of claim 9, further comprising returning to an ink mode after execution of the command.

16. The method of claim 9, further comprising retaining the desired user command for execution after returning to an inking mode.

17. A system that enables menu selection utilizing stroke gestures, comprising:
means for detecting and monitoring activation of a button;
means for determining that one or more objects are selected;
means for receiving a user desired action;
means for performing the desired action; and
means for returning to an inking mode.

18. The system of claim 17, the means for detecting and monitoring activation of a button cancels the desired action if the button is deactivated before the desired action performance begins.

19. The system of claim 17, the means for detecting and monitoring activation of a button does not cancel the desired action if the button is deactivated after the desired action performance begins.

20. The system of claim 17, the means for receiving a user desired action remembers that action for a subsequent button activation.
